(19) United States
(12) Patent Application Publication
(10) Pub. No.: US 2011/0191712 A1
(43) Pub. Date: Aug. 4, 2011

(54) PORTABLE TERMINAL

(75) Inventor: Satoshi MACHIDA, Kawasaki (JP)

(73) Assignee: Fujitsu Toshiba Mobile Communications Limited, Kawasaki-shi (JP)

(21) Appl. No.: 13/042,229

(22) Filed: Mar. 7, 2011

Related U.S. Application Data
(63) Continuation of application No. PCT/JP2008/066357, filed on Sep. 10, 2008.

(51) Int. Cl. G06F 3/048

(52) U.S. Cl. 715/788

(57) ABSTRACT

A portable terminal includes a display unit that displays an image based in image information; a touch panel overlapped by a display area on which the image is displayed; a move unit that moves a window in response to movement of an object while the object is in contact with any position within an area of the touch panel corresponding to a predetermined area of the window displayed by the display unit; a determining unit that determines whether a part of the window moved by the move unit goes out of the display area; and a display control unit that controls the display unit to change the display of the window to a predetermined size to nondisplay, and displays an image based on indication information representing the window when it is determined that the part of the window moved with the move unit goes out of the display unit.

### CROSS-REFERENCE TO RELATED APPLICATIONS

This application is a U.S. continuation application filed under 35 USC 111a and 365c of PCT application JP2008/066357, filed Sep. 10, 2008. The foregoing application are hereby incorporated herein by reference.

### FIELD

A certain aspect of the embodiments discussed herein is related to a portable terminal, especially to a portable terminal which is enabled to control display or nondisplay of a window displayed in a display unit.

### BACKGROUND

An example of a portable terminal has a pressure-sensitive touch panel or an electrostatic touch panel which are combined with a display unit. A user may instruct various processes using a window displayed in a display unit by operating a touch panel installed in a portable terminal with a pointing device such as a stylus pen or a user's finger.

In order to improve operability of windows displayed on the display unit, there is known a technique of supporting a size or a position of a window besides an operating method of the window as in Japanese Laid-open Patent Publication No. 2006-185025. Japanese Laid-open Patent Publication No. 2006-185025 discloses a change of a window size and a move of the window carried out at once by previously determining “size and coordinate of maximum window”, “size and coordinate of minimum window”, and “interrelation between size and coordinate”.

The following technique is known in a portable terminal having a touch panel. An occupied area of a touch panel having a size substantially the same as a display area of an ordinary display unit may be further enlarged, a dedicated area for the touch panel on which the display unit does not exist may be provided, and sections may be previously allocated for the dedicated area for the touch panel by each application. By operating the previously allocated sections with the pointing device, the application allocated to the section is activated.

However, in a portable terminal having a pressure-sensitive or electrostatic touch panel, a display area may be partly or totally hidden by various displayed window. Then, there is a problem that the limited display area may not be effectively used. It is possible to carryout the change and movement of the window size at once by applying the technique proposed in Japanese Laid-open Patent Publication No. 2006-185025 by previously setting up to do so. However, it is cumbersome work for a user. Even if the window size is changed and the window is moved, there is a display area which is hidden under the window at a position after moving the window. Therefore, it is still difficult to effectively use the display area.

### SUMMARY

According to an aspect of the embodiment, a portable terminal includes a display unit that displays an image based in image information; a touch panel overlapped by a display area on which the image is displayed; a move unit that moves a window in response to movement of an object while the object is in contact with any position within an area of the touch panel corresponding to a predetermined area of the window displayed by the display unit; a determining unit that determines whether a part of the window moved by the move unit goes out of the display area; and a display control unit that controls the display unit to change the display of the window having a predetermined size to nondisplay, and displays an image based on indication information representing the window when it is determined that the part of the window moved by the move unit goes out of the display unit.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an exterior appearance of a portable terminal of an embodiment of the present invention;

FIG. 2 illustrates a hardware configuration of the portable terminal of the embodiment of the present invention;

FIG. 3A and FIG. 3B illustrate a display area hidden under a window;

FIG. 4 is a flowchart illustrating a nondisplay control process for the window in the portable terminal of FIG. 2;

FIG. 5A to FIG. 5D illustrate transitions of a window displayed on the display unit and an iconized window;

FIG. 6A and FIG. 6B illustrate a window type displayed on the display unit;

FIG. 7 is a flowchart illustrating nondisplay of the window in the portable terminal of FIG. 2;

FIG. 8 is a flowchart illustrating another nondisplay control process for the window in the portable terminal of FIG. 2;

FIG. 9A and FIG. 9B illustrate transitions of a window displayed on the display unit and an iconized window;

FIG. 10 is a flowchart illustrating another nondisplay control process for the window in the portable terminal of FIG. 2;

FIG. 11 is a flowchart illustrating a control process of displaying a window again in the portable terminal of FIG. 2;

FIG. 12A and FIG. 12B illustrate a window displayed again on the display unit; and

FIG. 13 is a flowchart illustrating another nondisplay control process for the window in the portable terminal of FIG. 2.

### DESCRIPTION OF EMBODIMENT(S)

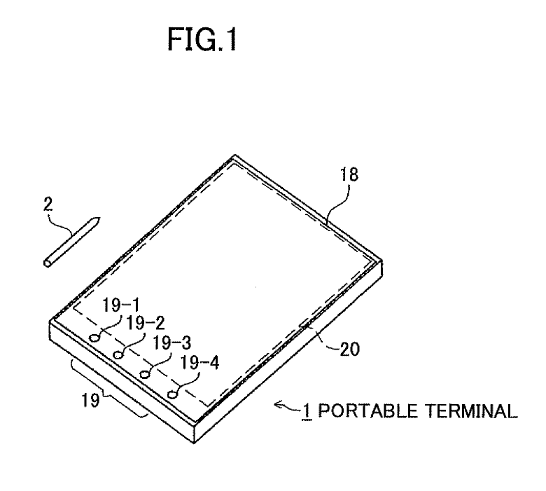

Preferred embodiments of the present invention are explained next with reference to accompanying drawings. FIG. 1 illustrates an exterior appearance of a portable terminal 1 of the embodiment. Referring to FIG. 1, with a sending and receiving antenna (not illustrated) at a predetermined position of the portable terminal 1, radio waves are sent to and received from a base station (not illustrated) via an integrated antenna.

The portable terminal 1 has an input unit 19 having operations keys 19-1 to 19-4 and various instructions are input by the input unit 19. A display unit 20 is provided on a front face of the portable terminal 1. The display unit 20 may be a display constituted by an organic EL or a liquid crystal display. A transparent touch panel 18 overlaps with and is bonded to the display unit 20. The touch panel is provided at a portion exceeding the display area of the display unit 20. A touch on the touch panel 18 with a stylus pen 2 or a finger is detected because the touch panel is a pressure-sensitive or electrostatic type. Needless to say, the touch panel 18 may be provided under the display unit 20.

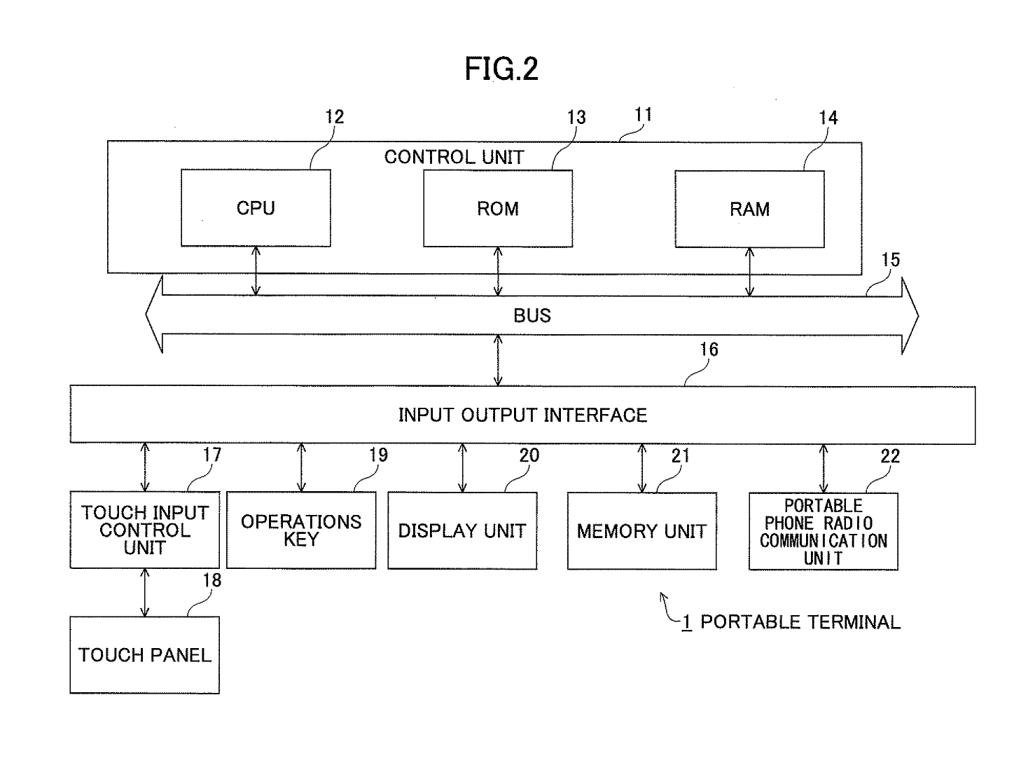

FIG. 2 illustrates a hardware configuration of the portable terminal 1 of the embodiment. As illustrated in FIG. 2, a control unit 11 includes a Central Processing Unit (CPU) 12, a Read Only Memory (ROM) 13, and a Random Access Memory (RAM) 14. The CPU 12 carries out various operations in conformity with a program stored in the ROM 13 and various application programs which are loaded in the RAM 14 from a memory unit 21 including an operating system, and generates various control signals and supplies the signals to various portions of the portable terminal 1 to thereby totally control the portable terminal 1. The RAM 14 properly stores data for carrying out the various processes.

The CPU 12, the ROM 13, and the RAM 14 are mutually connected via a bus 15. Further, an input output interface 16 is connected to the bus 15. The input unit 19 including the operations keys 19-1 to 19-4, the display unit 20, and the memory unit 21 including a hard disk or a nonvolatile memory are connected to the input output interface 16.

A touch input control unit 17 is connected to the input output interface 16. When a user does a touch input into the touch panel 18 with the stylus pen 2 or a user finger, the touch input control unit 17 detects coordinates (coordinates represented by two axes of X-axis and Y-axis) at which the touch input is carried out, and outputs a coordinate detection signal to the control unit 11. The coordinate detection signal includes coordinate values represented by the two axes of X-axis and Y-axis. With this, an input into the portable terminal 1 may be done through the touch panel 18.

A portable phone radio communication unit 22 is connected to the input output interface 16. The portable phone radio communication unit 22 is connected to a base station (not illustrated) via an integrated antenna (not illustrated) with a W-CDMA communication method or the like.

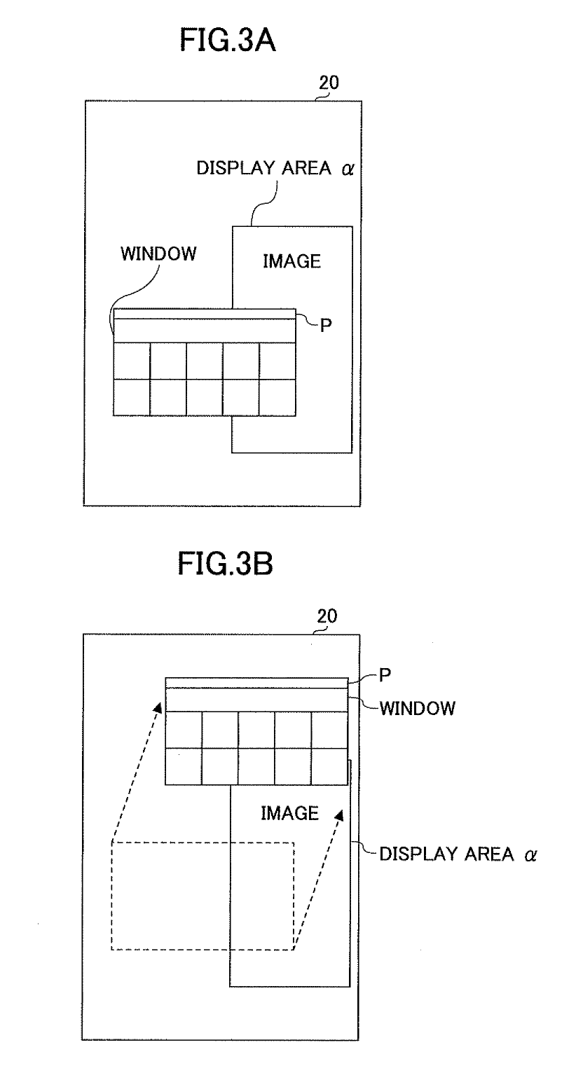

However, in a portable terminal 1 having a pressure-sensitive or electrostatic touch panel 18, a display area α may be partly or totally hidden by various displayed windows. Then, there is a problem that the limited display area α may not be effectively used. Referring to FIG. 3A, when the window is displayed on the display unit 20, there is an overlapping portion of a display area α of the display unit 20 on which an image is displayed and on which the window is displayed, and there is generated a portion of the display area α hidden under the window. As a result, it becomes impossible to display an image on the overlapping portion of the display area α. Thus, it becomes difficult to effectively use the limited display area α. When a transmission ratio of the window is set to be high, it becomes possible to display an image on the overlapping portion. However, it is still impossible to input via a window. Especially, when a user thinks it unnecessary to operate various windows, the windows are obstructive.

It is possible to carry out the change and movement of the window size at once by applying the technique proposed in Japanese Laid-open Patent Publication No. 2006-185025 by previously setting up to do so. However, it is cumbersome work for a user. Even if the size of the window is changed and the changed window is moved, or a title bar P of a window is dragged to be moved, a portion of the display area α hidden under the window is generated at a location to which the window is moved. Therefore, it is still difficult to effectively use the display area α.

With the embodiment, when the title bar P of the window moves from an initial setup position to a location in which a part of the window is moved out of the display area α0 of the display unit 20, the window is not displayed and is iconized at a predetermined area of the display unit 20. With this, the window displayed on the display unit 20 is not displayed in an appropriate manner during a sequence of a drag operation using the stylus pen 2 or a user's finger. Hereinafter, a window nondisplay control process using this method is described.

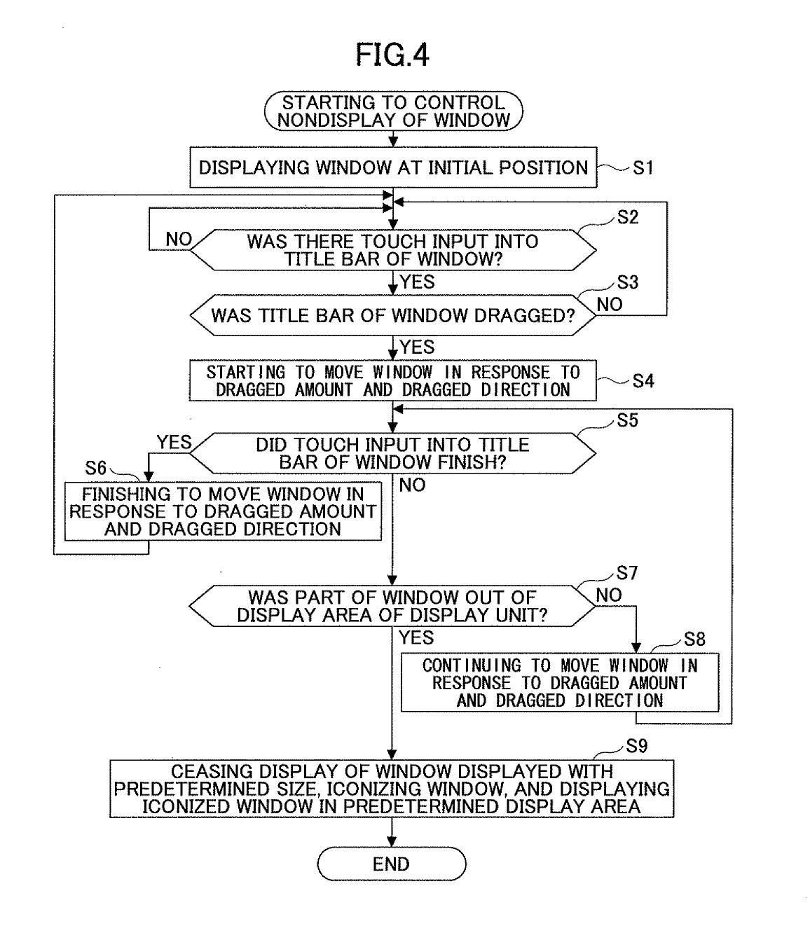

Referring to a flowchart of FIG. 4, the process of the nondisplay control in the portable terminal 1 is described. It is exemplified in the nondisplay control process of FIG. 4 that a user carries out a touch input with the stylus pen 2 as the pointing device. However, the embodiment is not limited to this case and also applicable to a case where the user carries out a touch input using a user's finger.

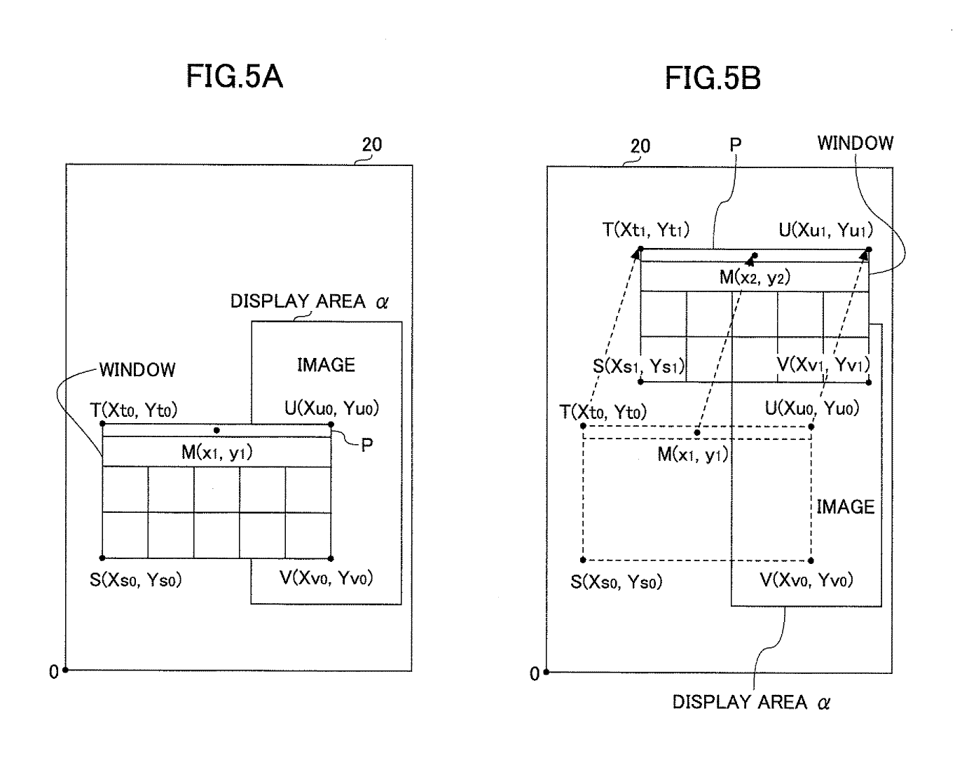

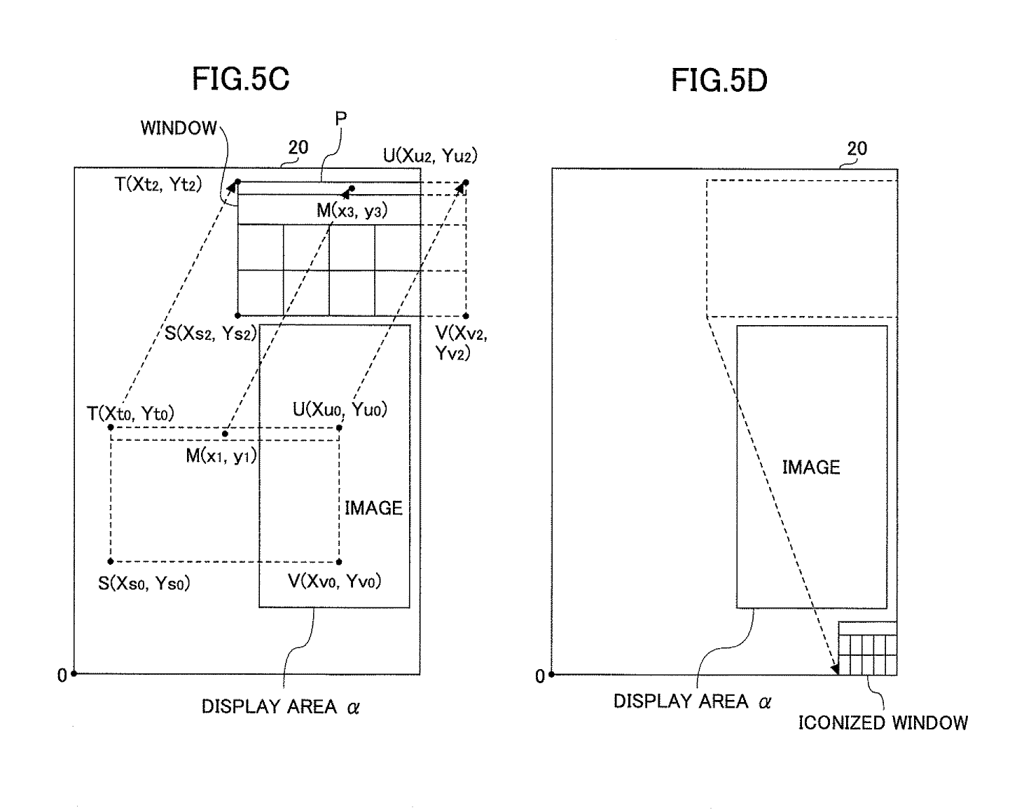

In step S1, when an instruction of displaying the window is received from the user by an operation of the user in the input unit 19, the CPU 12 of the control unit 11 controls the display unit 20 and causes the window to be displayed at a predetermined initial position. In the case of FIG. 5A, the window is arranged at a predetermined initial position, and coordinates of corners S, T, U and V are represented by S(Xs0,Ys0), T(Xt0,Yt0), U(Xu0,Yu0) and V(Xv0,Yv0).

In step S2, the CPU 12 of the control unit 11 determines whether there is a touch input into the title bar of the window based on a coordinate detection signal from the touch input control unit 17 obtained when the user brings down the stylus pen 2 to a predetermined display area α of the display unit 20. For example, when the stylus pen 2 as the pointing device is not operated and brought down on any part of the title bar of the window displayed on the display unit 20, it is determined that there is no touch input into the title bar of the window by the stylus pen 2. On the other hand, referring to FIG. 5A, when the stylus pen 2 is brought down on a coordinate point M(x₁, y₁) within the title bar of the window, it is determined that a touch input with the stylus pen on the title bar of the window exists.

When the CPU 12 of the control unit 11 determines that there is no touch input with the stylus pen 2 to the title bar of the window in step S2, the process waits at step S2. On the other hand, when it is determined that there is a touch input with the stylus pen 2 to the title bar of the window in step S2, the CPU 12 of the control unit 11 determines whether the title bar of the window is dragged after the touch input. Here, the terminology “drag” means an action of moving a stylus pen 2, a user's finger or the like from a first position on the touch panel at which the stylus pen 2, the user's finger or the like is first in contact with to a second position different from the first position while the stylus pen 2, the user's finger or the like keeps the contact with the touch panel.

Referring to FIG. 5B, when the stylus pen 2, the user's finger or the like moves from the first position M(x₁, y₁) (a position on the touch panel corresponding to any position within the title bar of the window displayed on the display unit 20), where the stylus pen 2, the user's finger or the like is first brought down on, to the second position M(x₂, y₂) while the stylus pen 2, the user's finger or the like keeps the contact with the touch panel, it is determined that the title bar of the window is dragged after the touch input with the stylus pen 2, the user's finger or the like in the title bar of the window.

When it is determined that the title bar of the window is not dragged after the touch input of the title bar of the window is done in step S3, the process returns to step S2.

When it is determined that the title bar of the window is dragged after the touch input of the title bar of the window is done in step S3, the CPU 12 of the control unit 11 controls the display unit 20 to move the window in response to the dragged amount and the dragged direction. Referring to FIG. 5B, since the position of the stylus pen is moved from M(x₁, y₁) to M(x₂, y₂), the window displayed on the display unit 20 starts to move in conformity with a distance between M(x₁, y₁) to M(x₂, y₂) i.e. the dragged amount [(x₂−x₁)²+(y₂−y₁)²]^{(1/2)} or a square root of (x₂−x₁)²+(y₂−y₁)², and the dragged direction from M(x₁, y₁) to M(x₂, y₂). More specifically, in conformity with the dragged amount and the dragged direction, the corners S, T, U and V moves to positions designated by S(Xs1,Ys1), T(Xt1,Yt1), U(Xu1,Yu1), and V(Xv1,Yv1).

In step S5, after the title bar of the window is started to be dragged, the CPU 12 of the control unit 11 determines whether the touch input into the title bar of the window has been finished by the user operating the stylus pen 2 based on the coordinate detection signal to thereby cease the touch input into the title bar of the window. When it is determined in step S5 that the touch input into the title bar of the window ceases, the display unit 20 is controlled to cease the movement of the window in response to the dragged amount and the dragged direction. Then, the movement of the window in response to the dragged amount and the dragged direction is finished. Thereafter, the process goes back to step S2, and the processes on and after step S2 are repeated.

When the CPU 12 determines that there still exists the touch input into the title bar of the window, the CPU 12 of the control unit 11 determines whether a part of the window displayed on the display unit 20 goes out of the display area α of the display unit 20 in step S7. Said differently, the CPU 12 of the control unit 11 determines whether at least one of the coordinates in the X and Y axes which indicate any corner of the four corners S, T, U and V is not included in the display area α of the display unit 20. For example, when at least one of the coordinates in the X and Y axes of the corners S, T, U and V exceeds the minimum value or the maximum value of the coordinates in the X and Y axes within the display area a of the display unit 220, it is determined that the one of coordinates is not included in the display area.

Referring to FIG. 5C, since the one of the coordinates of the X and Y axis which indicates the corners U and V of the window goes out of the display area α of the display unit 20, it is determined that the part of the window goes out of the display area α of the display unit 20.

In the embodiment, it is determined whether a part of the window goes out of the display area α of the display unit 20 for any one of the corners S, T, U and V. However, it can be determined when any point or part of the window goes out of the display area α.

When it is determined that the CPU 12 of the control unit 11 determines that a part of the window displayed on the display unit 20 does not go out of the display area α of the display unit 20, the CPU 12 of the control unit 11 continues to move the window in response to the direction of the dragged amount and the dragged direction, and the process goes back to step S5 in step S8. Then, the process returns back to step S5. With this the window is moved in response to the dragged amount and the dragged direction until any one of the coordinates in the X and Y axes indicative of the corners S, T, U and V is not contained in the display area α of the display unit.

In step S7, when the CPU 12 of the control unit 11 determines that the part of the window goes out of the display area of the display unit 20, the CPU 12 of the control unit 11 recognizes that the window displayed on the display unit 20 is instructed to be in a nondisplay state. Then, the CPU 12 controls the display unit 20 and ceases the display of the window in a predetermined size, and iconizes the window so as to be displayed on a predetermined display area (a display area which hardly obstructs watching an image displayed on the display unit 20). Referring to FIG. 5D, instead of the window display in the predetermined size, the iconized window is displayed on the lower right corner of the display area. The window may be displayed on a display area which does not obstruct watching of the image displayed on the display unit 20 such as the upper right corner, the lower right corner and the upper left corner.

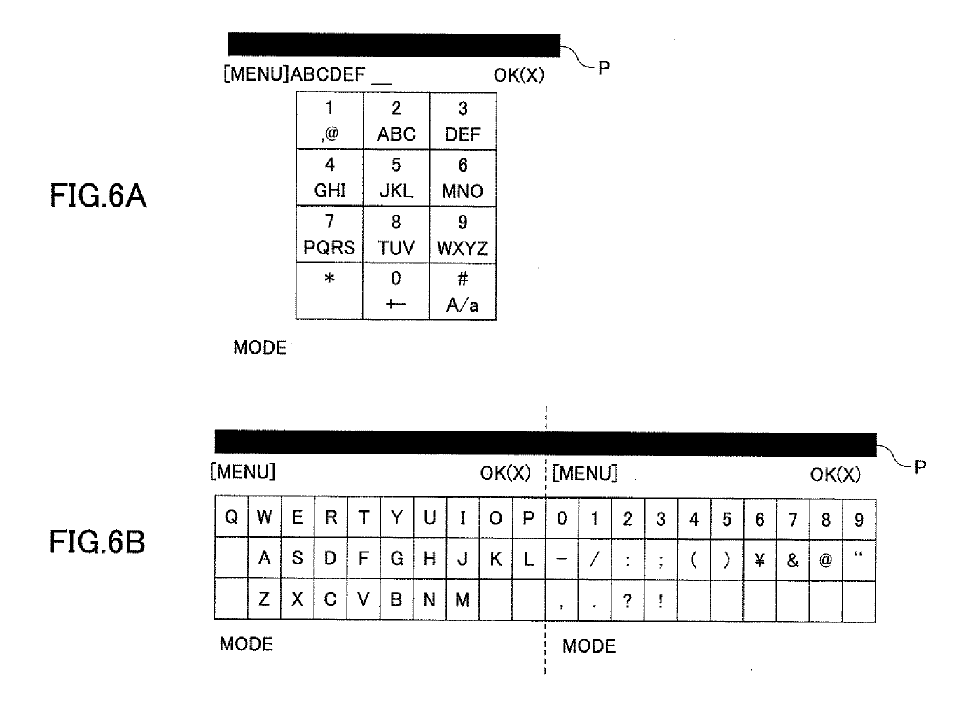

Types of windows displayed on the display unit 20 are described. FIG. 6A illustrates an example window related to a numeric keypad including ten keys. Referring to FIG. 6A, characters “A, B, C, D, E and F” are being input. On the left and right sides of a broken line of FIG. 6B, windows for inputting other characters are displayed. The windows on the left and right sides of a broken line of FIG. 6B can be switched over by pushing a “mode” key. Soft keys such as “menu” and “mode” may be displayed on both the left and right sides of the broken line of FIG. 6B. With this, the user can select a menu from “menu” of the window.

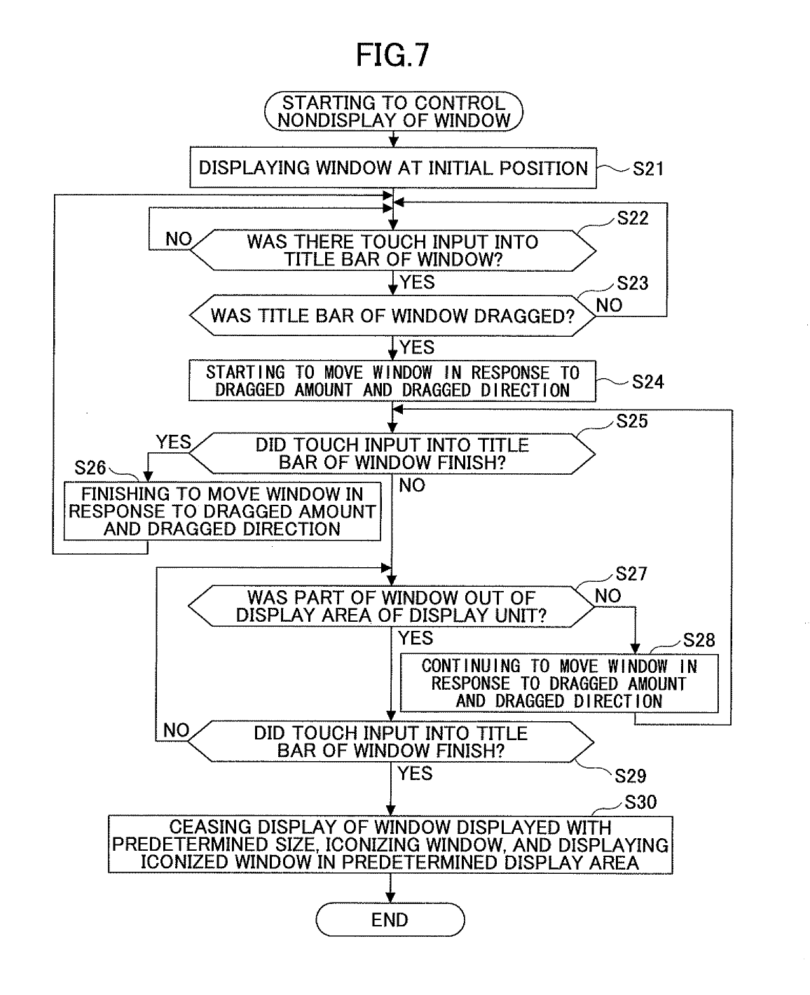

In the window nondisplay control process illustrated in reference of the flowchart of FIG. 4, when it is determined that a part of the window displayed on the display unit 20 goes out of the display area of the display unit 20, the window is iconized and displayed on the predetermined display area. The embodiment is not limited to this operation. For example, even when the part of the window displayed on the display unit is determined to go out of the display area of the display unit, only when the touch input into the title bar does not exist, the window is iconized and displayed on the predetermined display area. When there exists the touch input into the title bar of the window, the iconized window may be maintained. With this, the window is finally iconized when the touch input into the title bar of the window exists, and is not finally iconized when the touch input into the title bar of the window does not exist. Therefore, in consideration of usability, operability of the portable terminal 1 can be further improved. The nondisplay control process of the window is illustrated in FIG. 7.

Referring to a flowchart of FIG. 7, the process of the nondisplay control in the portable terminal 1 illustrated in FIG. 2 is described next. The processes of steps S21 to S28 and S30 are similar to the processes of steps S1 to S9 in FIG. 4. Therefore, the repetitive description is omitted.

In step S27, the CPU 12 of the control unit 11 determines that the part of the window displayed on the display unit 20 goes out of the display area of the display unit 20, the CPU 12 of the control unit 11 determines whether the touch input into the title bar of the window ceases in step S29. It is determined that the touch input ceases in step S29 when the stylus pen 2 is not in contact with the title bar of the window displayed on the predetermined display area of the display unit 20 when the user moves the stylus pen 2 based on the coordinate detection signal from the touch input control unit 17 in step S29. In step S29, when the CPU 12 of the control unit 11 determines that the touch input into the title bar of the window ceases, the CPU 12 of the control unit 11 recognizes that the nondisplay of the window is finally instructed by the user. The CPU 12 controls the display unit 20 in step S30 to change the display of the window having the predetermined size to the nondisplay, and iconizes the window and displays the iconized window on the predetermined area. On the other hand, when the CPU 12 of the control unit 11 determines that there is the touch input into the title bar, the CPU 12 of the control unit 11 recognizes that the nondisplay of the window is finally instructed by the user. Then, the process returns to step S27 and the processes on and after step S27 are repeatedly carried out.

In the case of the window nondisplay control process illustrated in the flowchart of FIG. 4, when the part of the window goes out of the display area of the display unit 20, regardless of whether any part of the window goes out of the display area of the display unit 20, the iconized window is always displayed at the predetermined display area. However, the embodiment is not limited to this. The display area of the iconized window may be changed in response to the window which has gone out of the display area of the display unit 20 depending on the portion of the window gone out of the display area of the display unit 20. Hereinafter, a window nondisplay control process using this method is described.

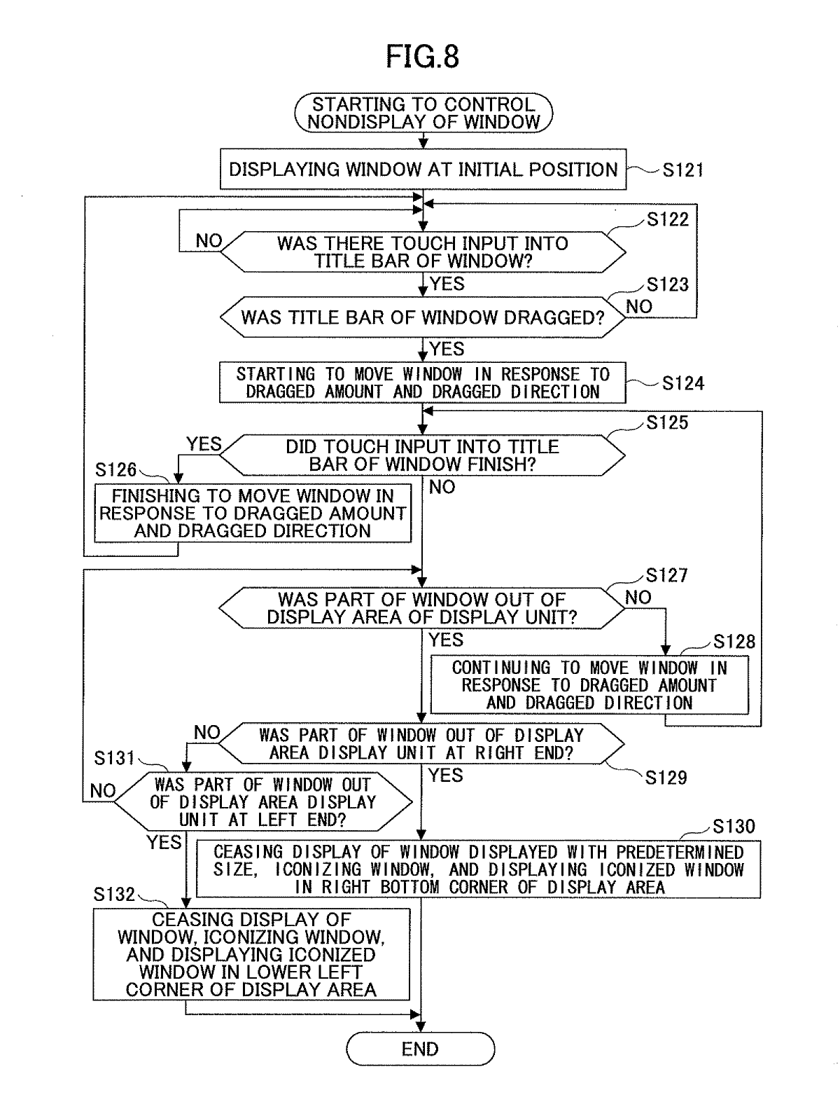

Referring to a flowchart of FIG. 8, the process of the nondisplay control in the portable terminal 1 illustrated in FIG. 2 is described next. The processes of steps S121 to S128 in FIG. 8 are similar to the processes of steps S1 to S8 in FIG. 4. Therefore, the repetitive description is omitted.

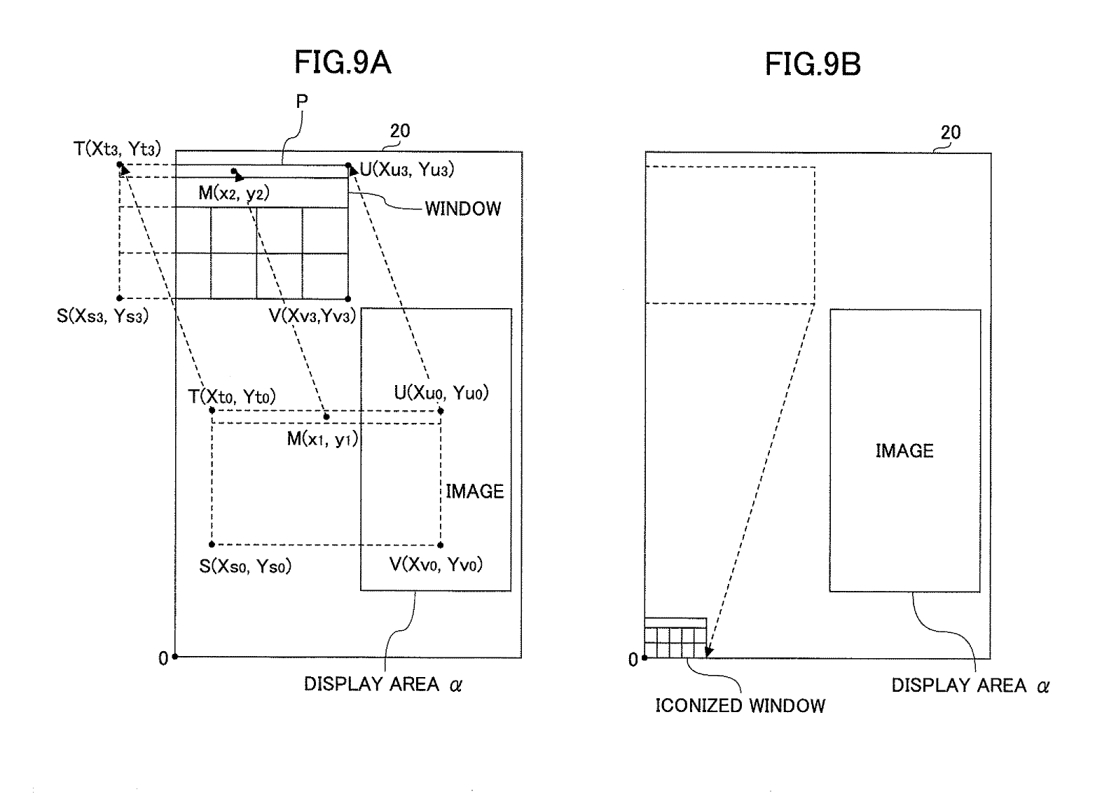

In step S129, the CPU 12 of the control unit 11 determines whether the part of the window gone out of the display area α is on the right end. Referring to FIG. 5C, because any one of the coordinates of the X and Y axis which indicate the corners U and V of the window goes out of the display area α of the display unit 20, it is determined that the part of the window gone out of the display area α of the display unit 20 is the right end of the window. Referring to FIG. 9A, because any one of the coordinates of the X and Y axis which indicate the corners T and S of the window goes out of the display area a of the display unit 20, it is determined that the part of the window gone out of the display area α of the display unit 20 is not the right end of the window.

When the CPU 12 of the control unit 11 determines that the part of the window gone out of the display area a of the display unit 20 is the right end, the CPU 12 of the control unit 11 recognizes that an instruction has been given to change from the display of the window displayed in the display unit 20 to the nondisplay thereof. Then, the CPU 12 controls the display unit 20 to change the display of the window displayed in the display unit 20 to the nondisplay, and iconizes the window and displays the iconized window in the display area α in the lower right corner. Referring to FIG. 5D, the iconized window is displayed on the display area α in the lower right corner.

On the other hand, when the CPU 12 of the control unit 11 determines that the part of the window has gone out of the display area α of the display unit 20, the CPU 12 of the control unit 11 further determines that the part of the window gone out of the display area α of the display unit is the left end. For example, in the case of FIG. 9A, because any one of the coordinates of the X and Y axis indicates the corners T and S of the window go out of the display area α of the display unit 20, it is determined that the part of the window gone out of the display area α of the display unit 20 is the left end of the window. In step S131, when the CPU of the control unit 11 determines that the part of the window gone out of the display area α of the display unit 20 is not the left end, the process goes back to step S127.

When the CPU 12 of the control unit 11 determines that the part of the window gone out of the display area a of the display unit 20 is the left end in step S131, the CPU 12 of the control unit 11 recognizes that an instruction has been given to change from the display of the window displayed in the display unit 20 to the nondisplay thereof. Then, the CPU 12 controls the display unit 20 to change the display of the window displayed in the display unit 20 to the nondisplay thereof, and iconizes the window and displays the iconized window in the display area in the lower left corner. Referring to FIG. 9B, the iconized window is displayed in the display area α on the lower left corner.

With this, even when the user operates the portable terminal 1 with only his or her right hand, the iconized window is displayed on the lower right corner. Thus, the operability in response to the operation with the right hand can be improved. Even when the user operates the portable terminal 1 with only his or her left hand, the iconized window is displayed on the lower left corner. Thus, in a similar manner to the right hand, the operability in response to the operation with the left hand can be improved.

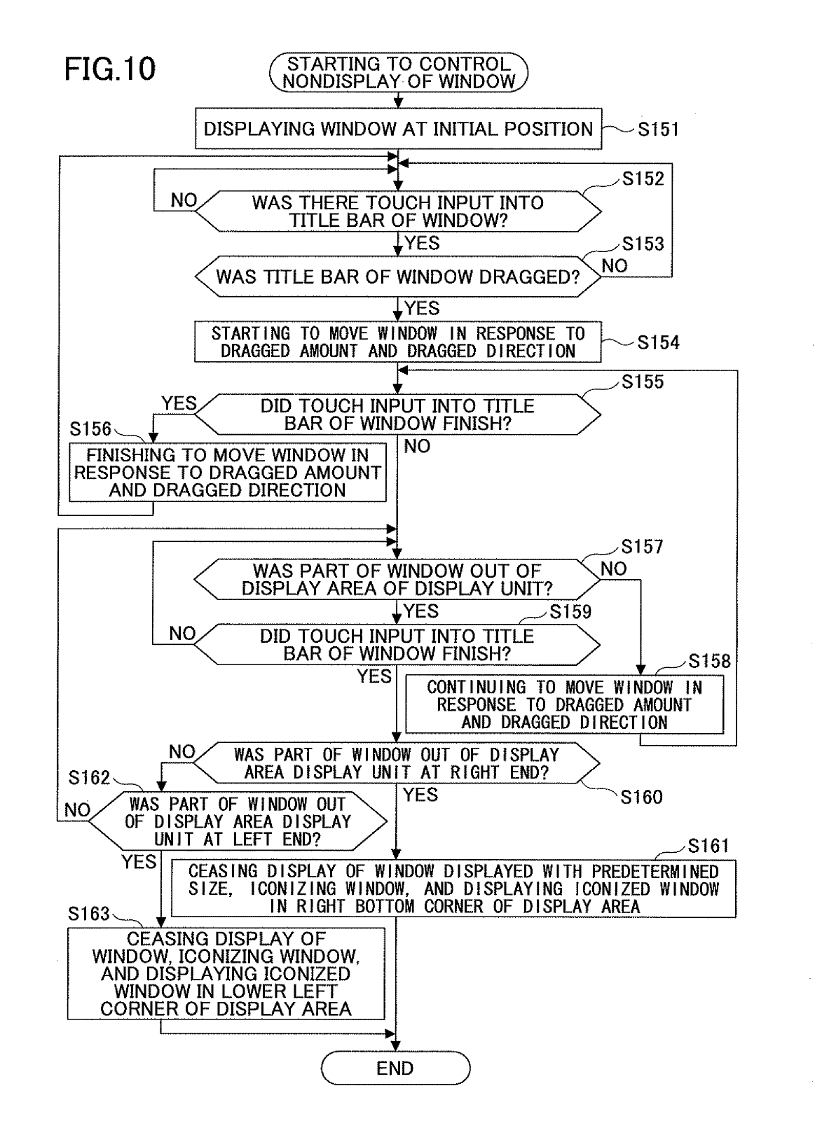

FIG. 10 illustrates a nondisplay control process in a case where a method of finally iconizing the window by determining a touch input into the title bar of the window as a trigger is applied to the window nondisplay control process illustrated in FIG. 8. The process of FIG. 10 is formed by combining the processes of FIG. 7 and FIG. 8. Repetitive description of the processes is omitted.

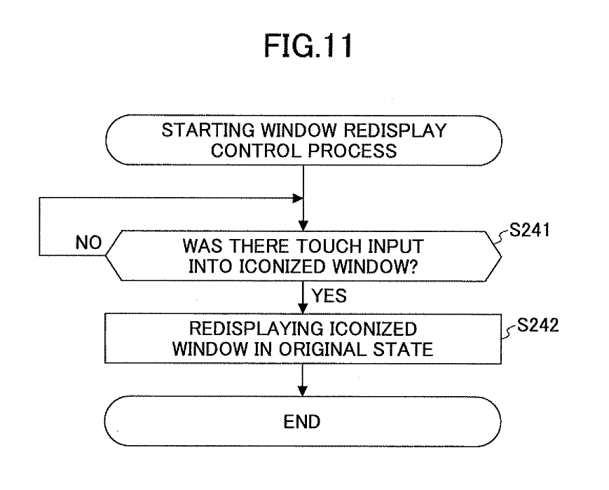

Referring to a flowchart of FIG. 11, a window redisplay control process in the portable terminal 1 illustrated in FIG. 2 is described next.

In step S241, the CPU 12 of the control unit 11 determines whether the touch input is given to the iconized window and waits until it is determined that the touch input is given to the iconized window. The determination is done based on the coordinate detection signal from the touch input control unit 17 when the iconized window is tapped on the touch panel 18.

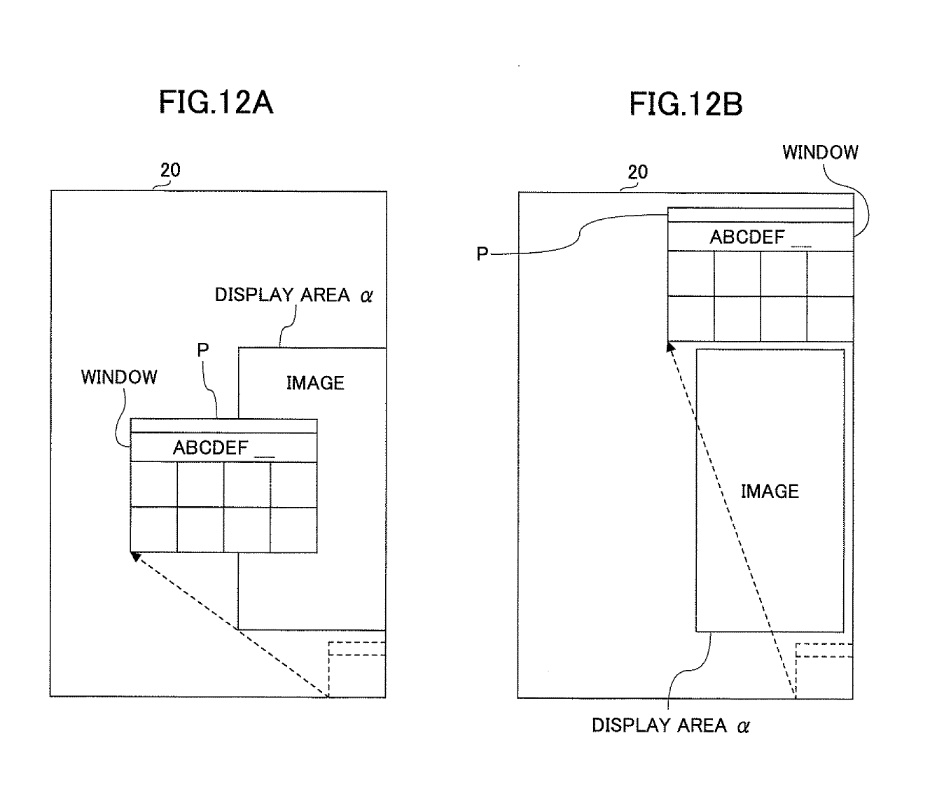

When the CPU 12 of the control unit 11 determines that the touch input is given to the iconized window in step S241, the CPU 12 of the control unit 11 controls the display unit 20 in step S242 to thereby redisplay the iconized window in an original state immediately before the nondisplay of the window. When the window moves as illustrated in FIG. 5A, FIG. 5B, FIG. 5C and FIG. 5D in this order while the touch input is maintained so that the window is ceased from being displayed (nondisplay), the window is redisplayed in the original state immediately before the nondisplay of the window illustrated in FIG. 5A. When the characters of “ABCDEF” are input in the state illustrated in FIG. 5A, the input “ABCDEF” are displayed again on the window in FIG. 12. The other states are maintained in a similar manner thereto. After the window moves by being dragged first in a range of the display area, the touch input is given to the title bar of the window again and the window is dragged so that the part of the window is brought outside the display area. In this case, the window is redisplayed at the position where the touch input has been given again.

When the iconized window is redisplayed, the redisplayed position may be any place. For example, the window may be redisplayed at a position within the display unit 20 and in the vicinity of a position out of the display area α as illustrated in FIG. 12B.

With the embodiment, the display unit 20 displays an image based on image information, moves a window in response to movement of an object such as a stylus pen 2 and a user's finger while keeping contact with the object with any position inside an area corresponding to a predetermined area of the window displayed on the display unit 20 of a touch panel 18 provided to overlap the display area, determines whether a part of the moved window went out of the display area, and ceases to display of the window in the predetermined size and displays the an image based on indication information representing the window. Thus, the display unit 20 can be controlled.

With this, it is possible to realize nondisplay or redisplay of a window displayed on a display unit 20 during a dragging operation using a stylus pen 2 or a user's finger. Thus, display or nondisplay of the window displayed on the display unit 20 can be suitably controlled by a touch input. Therefore, it is possible to reduce the display area hidden by the window as small as possible to thereby enable effectively using the limited display area. Further, a dedicated operation key for the nondisplay or the redisplay can be omitted. Therefore, additional work of attaching the dedicated operation key as hardware is omitted to thereby reduce the manufacturing cost. Further, the user can easily realize the nondisplay or the redisplay of the window by using the touch input into a window for inputting characters. Therefore, operability of the portable terminal 1 can be improved.

When the window is iconized and displayed, in order to make an image displayed on the display unit 20 be more easily watched, it is possible to increase the transmission ratio of the iconized window.

In the embodiment, when the part of the window displayed in the display unit 20 went out of the display area of the display unit 20, the window to be displayed in the predetermined size is ceased from being displayed and the iconized window is displayed in the predetermined display area. However, the embodiment is not limited to this case. When the stylus pen 2 moves along a locus of a predetermined shape such as a circle or a rectangle, the window may be ceased from being displayed and the iconized window and may be displayed in the predetermined display area. Hereinafter, a window nondisplay control process using this method is described.

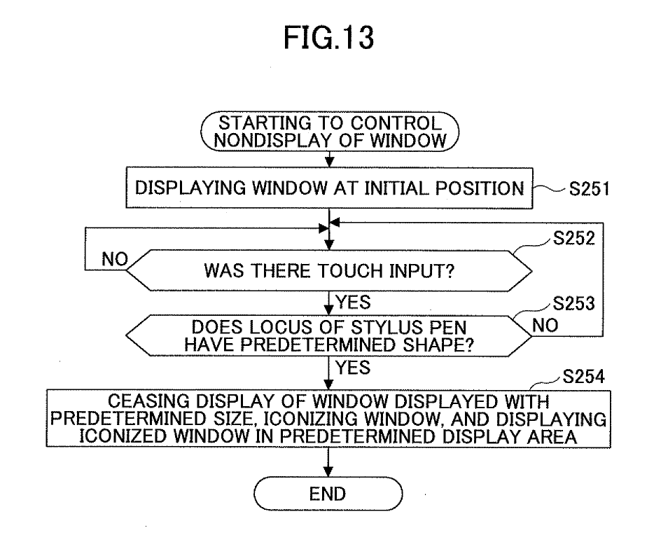

Referring to a flowchart of FIG. 13, another nondisplay control process in the portable terminal 2 illustrated in FIG. 2 is described next.

In step S251, when an instruction of displaying a window is received from a user by an operation of the user in the input unit 19, the CPU 12 of the control unit 11 controls the display unit 20 and causes the window to be displayed at a predetermined initial position as illustrated in FIG. 5A.

In step S252, when the user operates the stylus pen 2, the CPU 12 of the control unit 11 determines a position where the stylus pen 2 is brought down, determines whether there is a touch input, and waits until the touch input is determined based on a coordinate detection signal from the touch input control unit 17. When the CPU 12 determines that there is the touch input in step S252, the CPU 12 determines whether the locus of the stylus pen 2 moving on the touch panel 18 is a predetermined shape such as a circle and a rectangle in step S253.

When the CPU 12 determines that the locus of the stylus pen 2 moving on the touch panel 18 is the predetermined shape is step S253, the CPU 12 recognizes that an instruction of ceasing the display of the window is given to thereby control the display unit 20, change the display of the window of the predetermined size to the nondisplay of the window, and iconize the window as illustrated in FIG. 5D for displaying the iconized window in a predetermined area. The locus of the stylus pen 2 causing the nondisplay of the window may be registered in, for example, the memory unit or any other storage means of the user's choice.

When the CPU 12 of the control unit 11 determines that the locus of the stylus pen 2 moving on the touch panel 18 is not the predetermined shape, the process returns to step S252.

With this, it is possible to change the display of the window on the display unit 20 to the nondisplay or the redisplay. Thus, the display or the nondisplay of the window displayed on the display unit 20 can be preferable controlled by the touch input.

The embodiment is applicable to a Personal Digital Assistant (PDA), a personal computer, a portable music reproducer, a portable movie reproducer, or other portable terminals.

Further, the sequence of the processes described in the embodiment may be carried out by software or hardware.

Furthermore, the steps of the flowchart are examples of processes carried out in a temporal sequence along the described order. However, the processes may be carried out in this temporal sequence and may be carried out in parallel or in independent manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A portable terminal comprising:
a display unit that displays an image based in image information;
a touch panel overlapped by a display area on which the image is displayed;
a move unit that moves a window in response to movement of an object while the object is in contact with any position within an area of the touch panel corresponding to a predetermined area of the window displayed by the display unit;
a determining unit that determines whether a part of the window moved by the move unit goes out of the display area; and
a display control unit that controls the display unit to change the display of the window having a predetermined size to nondisplay, and displays an image based on indication information representing the window when it is determined that the part of the window moved by the move unit goes out of the display unit.

2. The portable terminal according to claim 1,
wherein the display control unit changes the display area on which the image is displayed in response to the part of the window gone out of the display area on which the image is displayed by the display unit.

3. The portable terminal according to claim 1,
wherein the determining unit determines that the part of the window moved by the move unit goes out of the display area when any one of coordinate values of an area of the window is larger than a maximum value or smaller than coordinate values of the display area on which the image is displayed by the display unit.

4. The portable terminal according to claim 1,
wherein the display control unit redisplays the window immediately before the nondisplay when the image displayed based on the indication information is displayed by the display unit and the object is in contact with any position inside the area of the touch panel corresponding to the image displayed based on the indication information while the image based on the indication information is displayed.

5. The portable terminal according to claim 1,
wherein the display control unit maintains the display of the window when the part of the window moved by the move unit goes out of the display area and the contact of the object with the touch panel is kept, and
changes the display of the window to the nondisplay of the window when the contact of the object with the touch panel is released.

6. A portable terminal comprising:
a display unit that displays an image based on image information;
a touch panel overlapped by a display area on which the image is displayed;
a determining unit that determines whether a locus of an object moving on the touch panel while the object is in contact with any position within an area of the touch panel corresponding to the display area of the display unit has a predetermined shape; and
a display control unit that controls the display unit to change the display of the window having a predetermined size to nondisplay, and displays an image based on indication information representing the window when the locus of the object has the predetermined shape.

7. A displaying method of a portable terminal having a display unit including a touch panel overlapped by a display area on which an image is displayed, the displaying method comprising:
displaying an image based in image information;
moving a window in response to movement of an object while the object is in contact with any position within an area of the touch panel corresponding to a predetermined area of the window;
determining whether a part of the moved window goes out of the display area;
controlling the display unit to change the display of the window having a predetermined size to nondisplay, and displaying an indicating image based on indication information representing the window when it is determined that the part of the moved window goes out of the display unit.

8. The displaying method according to claim 7,
wherein the controlling the display unit changes the display area on which the image is displayed in response to the part of the window gone out of the display area on which the image is displayed.

9. The displaying method according to claim 7,
wherein the determining determines that the part of the moved window goes out of the display area when any one of coordinate values of an area of the window is larger than a maximum value or smaller than coordinate values of the display area on which the image is displayed.

10. The displaying method according to claim 7,
wherein the controlling the display unit redisplays the window immediately before the nondisplay when the image displayed based on the indication information is displayed and the object is in contact with any position inside the area of the touch panel corresponding to the image displayed based on the indication information while the image based on the indication information is displayed.

11. The displaying method according to claim 7,
wherein the controlling the display unit maintains the display of the window when the part of the moved window goes out of the display area and the contact of the object with the touch panel is kept, and
changes the display of the window to the nondisplay of the window when the contact of the object with the touch panel is released.
